(19) United States
(12) Patent Application Publication
(10) Pub. No.: US 2025/0227187 A1
(43) Pub. Date: Jul. 10, 2025

(54) IMAGE FORMING APPARATUS, IMAGE FORMING METHOD, AND RECORDING MEDIUM

(71) Applicant: Konica Minolta, Inc., Tokyo (JP)

(72) Inventor: Koichi SAWADA, Tokyo (JP)

(21) Appl. No.: 19/013,560

(22) Filed: Jan. 8, 2025

(30) Foreign Application Priority Data
Jan. 9, 2024 (JP) 2024-000961

(51) Int. Cl. H04N 1/23; H04N 1/32; H04N 1/401

(52) U.S. Cl. CPC H04N 1/2323; H04N 1/32101; H04N 1/4015; H04N 2201/3269

(57) ABSTRACT

Disclosed is an image forming apparatus including: a conveyer; an image former; a first sheet reader on an upstream side; a hardware processor that causes the first sheet reader to read the sheet, generates image data of a base image based on unevenness information of the sheet surface, and controls to form the base image on the sheet; and a second sheet reader on a downstream side. The hardware processor causes the first sheet reader to read a correction sheet, generates image data of a correction base image based on unevenness information of the correction sheet surface, controls to form the correction base image on the correction sheet, causes the second sheet reader to read the correction sheet having the correction base image thereon, obtains a correction value from the read image, and corrects the image forming position in the image former based on the correction value.

### CROSS REFERENCE TO RELATED APPLICATIONS

The present invention claims priority under 35 U.S.C. § 119 to Japanese Application No. 2024-000961, filed on Jan. 9, 2024, the entire contents of which being incorporated herein by reference.

### BACKGROUND OF THE INVENTION

### Technical Field

The present invention relates to an image forming apparatus, an image forming method, and a recording medium.

### Description of Related Art

Conventionally, embossed paper has been used as one of printing sheets. In the embossed paper, a surface of a sheet is processed to be uneven. A read image obtained by reading embossed paper includes unevenness information.

For example, in a case where a one dimensional or two dimensional code image is formed on embossed paper, the image is interrupted or distorted due to the difference in level of unevenness on the surface of the sheet. Therefore, it is difficult to accurately reproduce the code image on the embossed paper. As a result, an abnormality may occur in reading of the code reader, and correct code information may not be obtained.

In addition, in a case where a patch image for automatic adjustment of density or color is formed on embossed paper, density unevenness occurs due to the difference in level of unevenness on the surface of the sheet, and the density of the patch image is not accurately reproduced. This is a factor that reduces the accuracy of automatic adjustment. Similarly, when an image for inspection is formed on embossed paper, automatic inspection cannot be performed in some cases.

As described above, it is necessary to improve the image quality of the code image, the patch image, and the like formed on the embossed paper and improve the printing accuracy.

In Japanese Unexamined Patent Publication No. 2022-35120, a technique is described in which a base image is formed with a transparent toner or a white toner on the surface of embossed paper to reduce the difference in level between recesses and projections, thereby improving the image quality of a code image formed thereon. Furthermore, in the technology described in Japanese Unexamined Patent Publication No. 2022-35120, a base image is formed only in a area of a code image, thereby suppressing consumption of toner.

In addition, in the image forming apparatus, it is considered that unevenness information including a pattern of the embossed paper is acquired, and the base image is formed so as to level the difference in level of the unevenness of the embossed paper. Specifically, the image forming apparatus forms the base image such that a larger amount of color material (toner or the like) is placed on a portion of the embossed paper having a larger amount of recess.

### SUMMARY OF THE INVENTION

However, in the image forming apparatus, when a base image corresponding to the uneven pattern of the embossed paper is to be formed, the position of the base image may be shifted with respect to the pattern of the embossed paper. In this case, it has been difficult for the image forming apparatus to realize a sheet surface without unevenness in a state including the base image.

Conventionally, a registration mark image is used for alignment of an image with respect to a sheet. For example, the image forming apparatus forms a registration mark image on a sheet and measures a misregistration from coordinates of the registration mark image obtained by reading the sheet, thereby correcting the position of the image. However, even when a registration mark image is formed on a sheet with a color material (white, transparent, or the like) suitable for a base image, it is difficult to accurately read the registration mark image.

The present invention has been made in consideration of the above-described problem in the related art, and an object of the present invention is to improve the position accuracy of a base image formed on a sheet having unevenness.

To achieve at least one of the abovementioned objects, according to an aspect of the present invention, an image forming apparatus reflecting one aspect of the present invention is an image forming apparatus including:
a conveyer that conveys a sheet;
an image former that forms an image on the sheet;
a first sheet reader provided on an upstream side from the image former in a sheet conveyance direction;
a hardware processor that causes the first sheet reader to read the sheet and generate a read image, generates image data of a base image based on unevenness information of a surface of the sheet acquired from the read image, and controls the image former to form the base image on the sheet based on the image data of the base image; and
a second sheet reader provided on a downstream side from the image former in the sheet conveyance direction, wherein the hardware processor
causes the first sheet reader to read a correction sheet and generate a first read image,
generates image data of a correction base image based on unevenness information of a surface of the correction sheet acquired from the first read image,
controls the image former to form the correction base image on the correction sheet based on the image data of the correction base image,
causes the second sheet reader to read the correction sheet on which the correction base image is formed and generate a second read image,
obtains a correction value related to an image forming position in the image former from the second read image, and
corrects the image forming position in the image former based on the correction value.

According to an aspect of the present invention, an image forming method reflecting one aspect of the present invention is an image forming method in an image forming apparatus including: a conveyer that conveys a sheet; an image former that forms an image on the sheet; a first sheet reader that is provided on an upstream side from the image former in a sheet conveyance direction; and a second sheet reader that is provided on a downstream side from the image former in the sheet conveyance direction, the method including:
causing the first sheet reader to read the sheet and generate a read image;
generating image data of a base image based on unevenness information of a surface of the sheet acquired from the read image;
controlling the image former to form the base image on the sheet based on the image data of the base image;
causing the first sheet reader to read a correction sheet and generate a first read image;
generating image data of a correction base image based on unevenness information of a surface of the correction sheet acquired from the first read image;
controlling the image former to form the correction base image on the correction sheet based on the image data of the correction base image;
causing the second sheet reader to read the correction sheet on which the correction base image is formed and generate a second read image;
obtaining a correction value related to an image forming position in the image former from the second read image; and
correcting the image forming position in the image former based on the correction value.

According to an aspect of the present invention, a recording medium reflecting one aspect of the present invention is a non-transitory recording medium storing a computer-readable program for a computer of an image forming apparatus including: a conveyer that conveys a sheet; an image former that forms an image on the sheet; a first sheet reader provided on an upstream side from the image former in a sheet conveyance direction; and a second sheet reader provided on a downstream side from the image former in the sheet conveyance direction, the program causing the computer to perform:
causing the first sheet reader to read the sheet and generate a read image;
generating image data of a base image based on unevenness information of a surface of the sheet acquired from the read image;
controlling the image former to form the base image on the sheet based on the image data of the base image;
causing the first sheet reader to read a correction sheet and generate a first read image;
generating image data of a correction base image based on unevenness information of a surface of the correction sheet acquired from the first read image;
controlling the image former to form the correction base image on the correction sheet based on the image data of the correction base image;
causing the second sheet reader to read the correction sheet on which the correction base image is formed and generate a second read image;
obtaining a correction value related to an image forming position in the image former from the second read image; and
correcting the image forming position in the image former based on the correction value.

### BRIEF DESCRIPTION OF THE DRAWINGS

The advantages and features provided by one or more embodiments of the invention will become more fully understood from the detailed description given hereinafter and the appended drawings which are given by way of illustration only, and thus are not intended as a definition of the limits of the present invention, and wherein:

FIG. 1 is a schematic configurational view of an image forming apparatus in a first embodiment of the present invention,

FIG. 2 is a block diagram illustrating the functional configuration of the image forming apparatus;

FIG. 3A is a diagram illustrating an example of embossed paper,

FIG. 3B is a diagram illustrating an example of a read image corresponding to a code image forming area,

FIG. 3C is a diagram illustrating an example of a code image,

FIG. 3D is a diagram illustrating a state in which a base image and a code image are formed on embossed paper,

FIG. 4 is a flowchart illustrating image forming processing,

FIG. 5A is an example in which a base image is formed in a concave portion of a code image forming area of embossed paper,

FIG. 5B is an example in which base images having different thicknesses are formed on the convex portion and the concave portion of the code image forming area of the embossed paper,

FIG. 5C is a comparative example in which a base image is formed with a uniform thickness in a code image forming area of embossed paper,

FIG. 6 is a flowchart illustrating the first image forming position correction processing,

FIG. 7A is an example of embossed paper on which a correction base image has been formed (in the case of no displacement),

FIG. 7B is an example of a binarized image obtained by binarizing a second read image obtained by reading embossed paper on which a correction base image is formed by a second sheet reading section,

FIG. 8A is another example of embossed paper on which a correction base image has been formed (in the case of displacement),

FIG. 8B is an example of a binarized image obtained by binarizing a second read image obtained by reading embossed paper on which a correction base image is formed by a second sheet reading section,

FIG. 9 is a flowchart illustrating second image forming position correction processing in the second embodiment,

FIG. 10 is an example of embossed paper on which a plurality of correction base images are formed,

FIG. 11 is a flowchart illustrating third image forming position correction processing in the third embodiment,

FIG. 12 is an example of embossed paper on which a plurality of correction base images and a code image are formed,

FIG. 13 is an example in which a base image is formed with toners of two colors in a concave portion of a code image forming area of embossed paper in the image forming apparatus of Modification example 1; and

FIG. 14 is an enlarged view showing the periphery of the reversing section of the image forming apparatus of Modification example 2.

### DETAILED DESCRIPTION

Hereinafter, one or more embodiments of the present invention will be described with reference to the drawings. However, the scope of the invention is not limited to the disclosed embodiments.

### First Embodiment

First, a first embodiment of the present invention will be described.

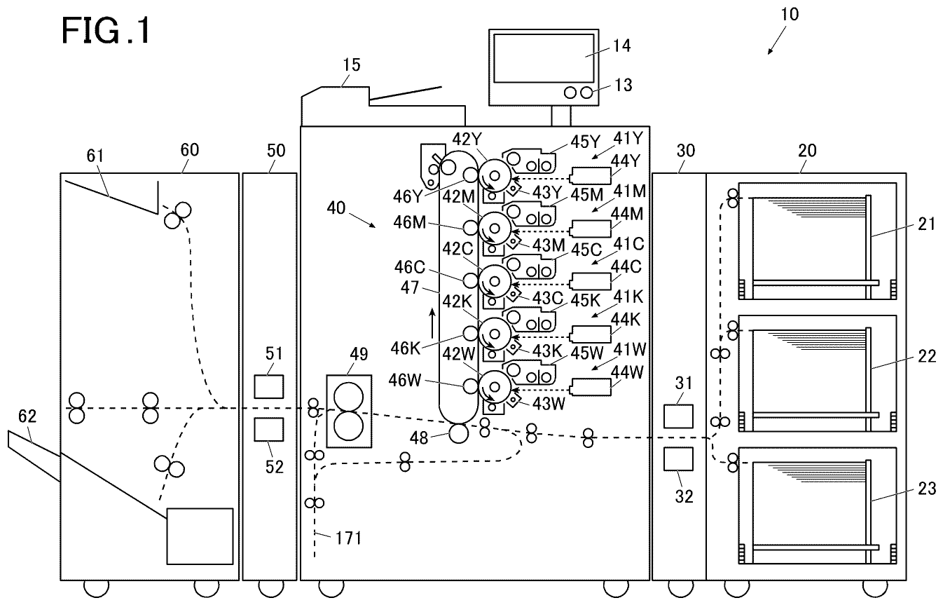

FIG. 1 is a schematic configuration diagram of an image forming apparatus 10 according to the first embodiment.

The image forming apparatus 10 forms a color image on a sheet by an electrophotographic method based on image data. The image data may be image data obtained by reading an image from a document or image data received from an external device.

The image forming apparatus 10 includes an operation part 13, a display part 14, a document reading unit 15, a sheet feed section 20, a first sheet reading section 30 (first sheet reader), an image forming section 40 (image former), a reversing section 171 (reverser), a second sheet reading section 50 (second sheet reader), a post-processing section 60, and the like.

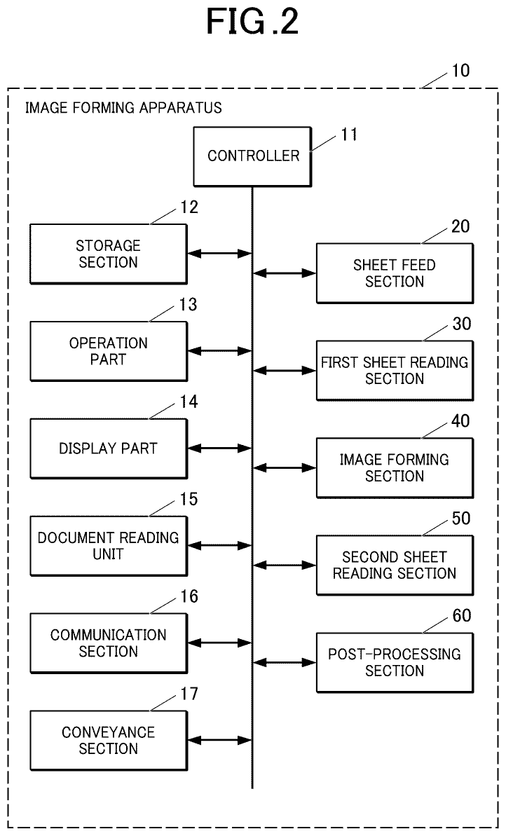

The operation part 13 includes various operation buttons and a touch screen. The operation part 13 outputs an operation signal based on a user operation to the controller 11 (hardware processor) (see FIG. 2). The various operation buttons include numeric buttons, a start button, and the like. The touch screen is provided so as to cover the display screen of the display part 14.

The display part 14 is composed of a liquid crystal display (LCD). The display part 14 displays various screens according to an instruction of a display signal input from the controller 11.

The document reading unit 15 includes an automatic document feeder (ADF) and a scanner. The document reading unit 15 outputs image data obtained by reading the image of the document to the controller 11.

The sheet feed section 20 includes sheet feeding trays 21, 22, and 23 and supplies sheets to the image forming section 40. The sheet feed trays 21, 22, and 23 store sheets of a predetermined paper type and size for each sheet feed tray.

The first sheet reading section 30 is provided on a downstream side of the sheet feed section 20 and on an upstream side of the image forming section 40 in a sheet conveyance direction. The first sheet reading section 30 reads a sheet and generates a read image. The first sheet reading section 30 receives, with the light receiving elements, light emitted from the light source and reflected off the surface of the sheet, and outputs signals corresponding to the intensity of the light. The first sheet reading section 30 is a line sensor in which a plurality of light receiving elements are arranged at predetermined intervals in a direction orthogonal to the sheet conveyance direction. The first sheet reading section 30 includes a reading sensor 31 that reads a first surface (upper surface in FIG. 1) of the sheet and a reading sensor 32 that reads a second surface (lower surface in FIG. 1) of the sheet. The first sheet reading section 30 can read both sides of the sheet with the reading sensors 31 and 32 at the same time when the sheet is conveyed through the first sheet reading section 30. Here, a contact image sensor (CIS) is used as the reading sensors 31 and 32. Note that the first sheet reading section 30 may be a charge coupled device (CCD) image sensor. The first sheet reading section 30 is not limited to a line sensor and may be an area sensor. The first sheet reading section 30 reads the correction sheet to generate a first read image. The correction sheet is a sheet used for correction (adjustment) of the image forming position.

The first sheet reading section 30 has been conventionally used for, for example, measuring the size of a sheet and aligning the positions of images formed on the front and back faces of the sheet on the basis of the result of the measurement.

The image forming section 40 forms an image on the sheet supplied by the sheet feed section 20.

The image forming section 40 includes image creating sections 41Y, 41M, 41C, 41K, and 41W (image creators) corresponding to respective colors of yellow (Y), magenta (M), cyan (C), black (K), and white (W). The image forming section 40 includes an intermediate transfer belt 47, a secondary transfer roller 48, and a fixing section 49. The image creating sections 41Y, 41M, 41C, 41K, and 41W are arranged in series (tandem) along the belt surface of the intermediate transfer belt 47.

The image creating section 41Y includes a photosensitive drum 42Y, a charging section 43Y, an exposure section 44Y, a developing section 45Y, and a primary transfer section 46Y. The image creating section 41Y forms a yellow image on the intermediate transfer belt 47. The charging section 43Y uniformly charges the surface of the photosensitive drum 42Y. The exposure section 44Y scans and exposes the charged photosensitive drum 42Y with a laser beam based on the image data of the color yellow so as to form an electrostatic latent image. Developing section 45Y applies yellow toner to the electrostatic latent image on photosensitive drum 42Y and develops the image. The primary transfer section 46Y transfers the yellow toner image formed on the photosensitive drum 42Y onto the rotating intermediate transfer belt 47 (primary transfer).

The image creating sections 41M, 41C, 41K, and 41W are the same as the image creating section 41Y except that they handle different colors, and therefore, description thereof is omitted. The image creating section 41W is an image creating section for forming a base image (white image).

On the intermediate transfer belt 47, a color toner image in which toner images of up to five colors are superimposed is formed. Toner images are formed on the intermediate transfer belt 47 in the order of yellow, magenta, cyan, black, and white.

The secondary transfer roller 48 collectively transfers the color toner image on the intermediate transfer belt 47 onto a sheet (secondary transfer).

The fixing section 49 includes a heating roller and a pressure roller. The fixing section 49 fixes the color toner image to the sheet by heating and pressing.

The reversing section 171 reverses the sheet when images are formed on both sides of the sheet. The reversing section 171 reverses the sheet conveyed to the downstream side from the image forming section 40 in the sheet conveyance direction, and supplies the reversed sheet to the image forming section 40 again.

The second sheet reading section 50 is provided on the downstream side of the image forming section 40 and on the upstream side of the post-processing section 60 in the sheet conveyance direction. The second sheet reading section 50 reads a sheet on which a correction base image is formed (correction sheet), and generates a second read image. The correction base image is an image used for correction (adjustment) of the image forming position. The second sheet reading section 50 is a line sensor similar to the first sheet reading section 30, and thus detailed description thereof will be omitted. The second sheet reading section 50 includes a reading sensor 51 that reads a first surface (upper surface in FIG. 1) of the sheet, and a reading sensor 52 that reads a second surface (lower surface in FIG. 1) of the sheet. The second sheet reading section 50 can read both sides of the sheet with the reading sensors 51 and 52 at the same time when the sheet is conveyed through the second sheet reading section 50. Here, CIS is used as the reading sensors 51 and 52. Note that the second sheet reading section 50 may be a CCD image sensor. Further, the second sheet reading section 50 is not limited to a line sensor, and may be an area sensor.

The second sheet reading section 50 is conventionally used to inspect an image forming state, optimize the setting of the image forming section 40 based on the inspection result, and detect a waste sheet.

The post processing section 60 performs post processing, if necessary, on the sheet conveyed from the image forming section 40. The post-processing includes stapling processing, cutting processing, punching processing, folding processing, sorting processing, and the like. The post-processing section 60 includes sheet ejection trays 61 and 62.

FIG. 2 is a block diagram illustrating the functional configuration of the image forming apparatus 10.

As illustrated in FIG. 2, the image forming apparatus 10 includes a controller 11, a storage section 12, an operation part 13, a display part 14, an document reading unit 15, a communication section 16, a conveyance section 17 (conveyer), a sheet feed section 20, a first sheet reading section 30 (first sheet reader), an image forming section 40 (image former), a second sheet reading section 50 (second sheet reader), a post processing section 60, and the like. Description of the functional components already described will be omitted.

The controller 11 includes a central processing unit (CPU), a read only memory (ROM), a random access memory (RAM), and the like. The CPU reads various processing programs stored in the ROM in response to an operation signal input from the operation part 13 or an instruction signal received by the communication section 16. The CPU develops the read program in the RAM, and controls the operation of each unit of the image forming apparatus 10 according to the program.

The storage section 12 is configured by a storage device such as a hard disk or a flash memory. The storage section 12 stores various types of data.

The communication section 16 transmits and receives data to and from an external device connected to a communication network such as a local area network (LAN).

The conveyance section 17 includes conveyance rollers. The conveyance section 17 conveys a sheet in the image forming apparatus 10. For example, the conveyance section 17 supplies sheets stored in sheet feed trays 21, 22, and 23 of the sheet feed section 20 to the image forming section 40 via the first sheet reading section 30. The conveyance section 17 conveys the sheet after image formation to the post-processing section 60 via the second sheet reading section 50, and ejects the sheet to sheet ejection trays 61 and 62. The conveyance section 17 includes a reversing section 171.

The controller 11 acquires unevenness information of the surface of the sheet from the read image generated by the first sheet reading section 30. The unevenness information is information indicating the unevenness of the surface of the sheet. The unevenness information includes at least information indicating whether the surface of the sheet is raised or recessed from a reference position. Further, the unevenness information includes information indicating the degree of unevenness. The controller 11 acquires, for example, unevenness information indicating that a pixel is more recessed as the density is higher (the brightness is lower), in accordance with the shading (gradation value) of each pixel of the read image. That is, in the read image, a area having a relatively high density corresponds to a concave portion of the embossed paper, and a area having a relatively low density corresponds to a convex portion of the embossed paper. In addition, it is estimated that a area having a higher density corresponds to a area in which the depth of the concave portion in the embossed paper is deeper.

Note that the method of acquiring the unevenness information does not have to be as fine as the shading of the read image. The level obtained by dividing the degree of unevenness into a plurality of levels may be used as the unevenness information.

The controller 11 generates image data of the base image on the basis of the unevenness information acquired from the read image. Specifically, the controller 11 generates image data of a base image so as to fill concave portions (grooves) in the surface of the sheet with a color material (toner). For example, the controller 11 generates the image data of the base image such that the toner for the base image is placed only in the concave portions of the sheet. Alternatively, controller 11 generates the image data of the base image such that more toner for the base image is placed on concave portions than on convex portions of the sheet.

The controller 11 controls the image forming section 40 to form a base image on a sheet on the basis of the image data of the base image. The controller 11 causes the base image to be formed so as to be closer to the sheet than the image (main image) in the image forming job. The image forming job includes a print job, a copy job, and the like.

The controller 11 causes a base image to be formed in a partial area on the sheet. The “partial area” is a area in which an inspection image, a test pattern image, a registration mark image, or a code image having information in a one dimensional or two dimensional direction is formed.

The code image having information in a one dimensional direction (one dimensional code image) is, for example, a barcode. The code image having information in two dimensional directions (two dimensional code image) is, for example, a QR code (R). The code image can provide code information by being read by a code reader.

The inspection image is an image for inspecting whether quality to be inspected does not deviate from a predetermined criterion. As the inspection image, for example, a patch image having a predetermined color or density, a thin line image, or the like is used. If the inspection image formed on the sheet does not satisfy the predetermined quality, the sheet is ejected as waste sheet to a sheet ejection tray different from that for normal sheets.

The test pattern images are images for adjusting color, density, and the like. For example, when a test pattern image for adjusting the density is formed on a sheet, the controller 11 feeds back the measurement result of the density of the test pattern image to a density adjustment value.

The registration mark image is an image used as a reference for alignment, image magnification, cutting processing, folding processing, and the like.

The controller 11 causes the base image to be formed in a color different from that of the image (main image) in the image forming job. Note that the color of the base image is not necessarily different from all the colors used in the entire sheet in the image forming job among YMCK. The color of the base image may be at least different from the color used for the main image (code image or the like) formed in the area where the base image is formed. For example, since a barcode and a QR code are usually formed in black, it is desirable that the color of the base image in the area where the code image is formed be a color other than black.

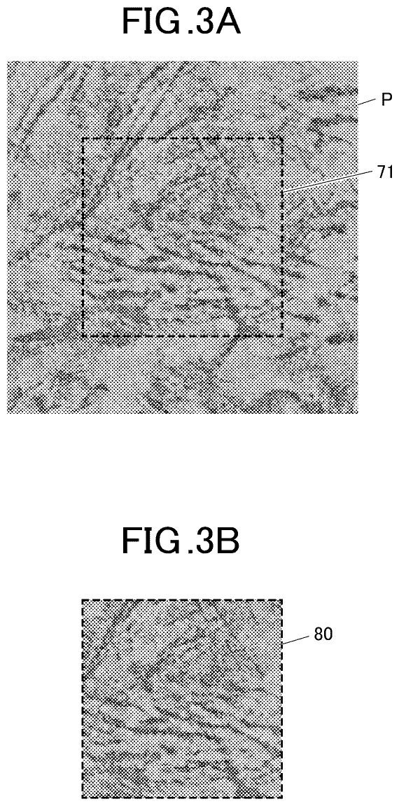

FIG. 3A shows an example of embossed paper P on which an image is to be formed. The code image forming area 71 of the embossed paper Pis an area where a code image is formed.

An example of a read image 80 corresponding to the code image forming area 71 of the embossed paper P is illustrated in the 3B of the drawing. In the read image 80, black portions (high-density portions) are groove portions (concave portions) of the embossed paper P. The controller 11 generates the image data of the base image such that a thicker base image is formed in a high density portion of the read image 80. The controller 11 may use the density (gradation value) of each pixel of the read image 80 as it is as the white component of the base image.

FIG. 3C illustrates an example of a code image 81 (QR (code).

The 3D of the figure shows a state where the base image 82 (white image) and the code image 81 are formed in the code image forming area 71 of the embossed paper P. The code image 81 is formed above the layer of the base image 82 with respect to the embossed paper P.

When the base image formed on the sheet is shifted with respect to the pattern of the embossed paper, the image forming apparatus 10 cannot achieve the original purpose of forming the code image or the like with high accuracy. Therefore, the controller 11 needs to correct the image forming position.

The controller 11 causes the first sheet reading section 30 to read the correction sheet and generate a first read image. The controller 11 acquires unevenness information of the surface of the correction sheet from the first read image generated by the first sheet reading section 30. Since the method of acquiring the unevenness information has already been described, detailed description will be omitted.

Based on the unevenness information acquired from the first read image, the controller 11 generates image data of a correction base image. The method of generating the image data of the correction base image is the same as the method of generating the image data of the base image described above. A target area (target position) when the correction base image is formed is determined in advance.

The controller 11 controls the image forming section 40 to form the correction base image on the correction sheet on the basis of the image data of the correction base image.

The controller 11 causes the second sheet reading section 50 to read the correction sheet on which the correction base image is formed and generate a second read image.

The controller 11 obtains a correction value related to an image forming position in the image forming section 40 from the second read image generated by the second sheet reading section 50. Specifically, the controller 11 calculates, from the second read image, the misregistration amount of the correction base image with respect to the correction sheet, and obtains the correction value from the misregistration amount.

The controller 11 corrects the image forming position in the image forming section 40 based on the correction value.

Next, operation of the image forming apparatus 10 will be described.

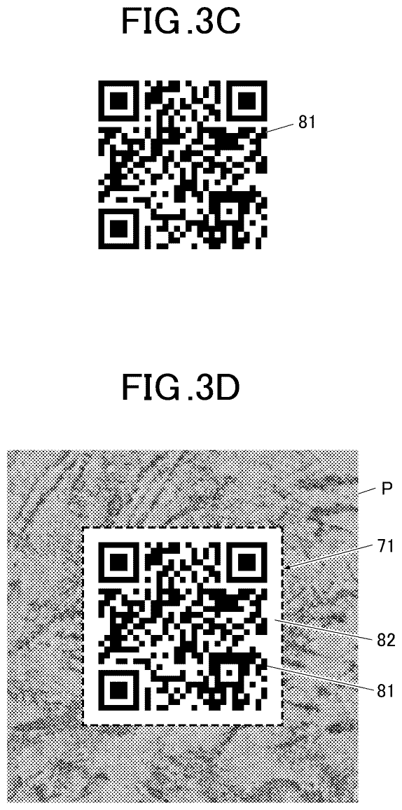

FIG. 4 is a flowchart illustrating image forming processing executed in the image forming apparatus 10. The image forming processing is processing for forming an image including a code image on embossed paper. This processing is implemented by software processing in cooperation with the CPU of the controller 11 and a program stored in the ROM.

First, the controller 11 acquires a document image (step S1). In the case of a print job, the controller 11 acquires document image data received from the external device via the communicator 16. In the case of a copy job, the controller 11 acquires image data of a document read by the document reading unit 15.

Next, the controller 11 detects a code area from the document image (step S2). The controller 11 compares the document image data with a predetermined pattern for recognizing a code image, and recognizes the code image from the document image data. Next, the controller 11 detects, from the document image data, a rectangular area in which the code image is captured as a code area. The controller 11 causes the storage section 12 to store information indicating the position of the code area. For example, the coordinates of the four corners of the code area (rectangular area) in the document image data are used as the information indicating the position of the code area.

Next, the controller 11 controls the conveyance section 17 to cause the sheet (embossed paper) to be conveyed toward the first sheet reading section 30 from the specified sheet feed tray 21, 22, or 23 of the sheet feed section 20. The controller 11 controls the first sheet reading section 30 to read the surface of the sheet and generate a read image (step S3). For single-sided printing, the controller 11 allows the reading sensor 31 to read the upper surface of the embossed paper. In double-sided printing, the controller 11 allows the reading sensors 31 and 32 to read the upper and lower surfaces of embossed paper. The controller 11 acquires the read image from the first sheet reading section 30. The controller 11 may allow the first sheet reading section 30 to read the surface of the sheet only in the code image forming area of the sheet.

Next, the controller 11 acquires the unevenness information of the code image forming area from the read image (step S4). Prior to step S4, the controller 11 identifies the code image forming area of the read image on the basis of the information indicating the position of the code area stored in the storage section 12.

The controller 11 generates the image data of the base image on the basis of the unevenness information of the code image forming area (step S5). The image data of the base image is composed of shading (gradation value) corresponding to the unevenness of the embossed paper. Specifically, the controller 11 generates the image data of the base image such that the toner amount of the image formed with the white toner is larger in a area of the read image having a higher density. That is, as the grooves are deeper, a larger amount of white toner is placed on the concave portions of the embossed paper. The controller 11 adjusts the quality of the finished image by performing image processing, such as tone correction or spatial filtering, on the base image (white image).

The controller 11 combines the image data of the base image with the document image data (step S6). When the document image data includes a white component, the controller 11 combines the image data of the base image with the white component of the document image data.

The controller 11 controls the image forming section 40 to form the document image (the main image) and the base image on the basis of the combined image (step S7).

To be specific, the controller 11 causes the image creating sections 41Y, 41M, 41C, and 41K to form toner images of the respective colors on the photosensitive drums 42Y, 42M, 42C, and 42K based on the document image data. The controller 11 causes the toner images in the respective colors formed on the photosensitive drums 42Y, 42M, 42C, and 42K to be sequentially transferred onto the intermediate transfer belt 47. The document image includes a code image.

Further, the controller 11 causes the image creating section 41W to form a white toner image (base image) on the photosensitive drum 42W. The controller 11 causes the white toner image formed on the photosensitive drum 42W to be transferred onto the intermediate transfer belt 47. Here, in the area where the code image is formed on the intermediate transfer belt 47, the white toner image is formed on the outermost side.

The controller 11 causes the secondary transfer roller 48 to collectively transfer the document image and the base image formed on the intermediate transfer belt 47 onto a sheet. Controller 11 causes fixing section 49 to fix the sheet having the document image and the base image transferred thereon.

Thus, the image forming processing ends.

### (Base Image Example 1)

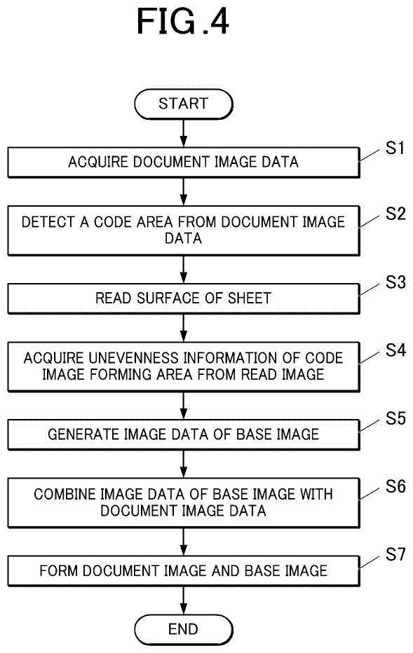

FIG. 5A is an enlarged view illustrating a cross section of the embossed paper P when the base image is formed in the concave portion Pb of the code image forming area 71 of the embossed paper P. The embossed paper P has convex portions Pa and concave portions Pb. The white toner layer Tw is formed as a base image in the concave portion Pb in the code image forming area 71 of the embossed paper P. On the other hand, no base image is formed on the convex portions Pa even in the code image forming area 71. In the code image forming area 71, a black toner layer Tk is formed in a black area 72 in which a black image is formed. Thus, in the code image forming area 71 of the embossed paper P, the difference in level between the convex portion Pa and the concave portion Pb can be reduced.

### (Base Image Example 2)

FIG. 5B is an enlarged view illustrating a cross section of the embossed paper P when a base image is formed in a code image forming area 71 of the embossed paper P. In the code image forming area 71 of the embossed paper P, the white toner layer Tw is formed as a base image on both the convex portion Pa and the concave portion Pb. However, the thickness of the white toner layer Tw is different between the convex portion Pa and the concave portion Pb. As illustrated in FIG. 5B, the white toner layer Tw formed on the concave portions Pb is thicker than the white toner layer Tw formed on the convex portions Pa. The black toner layer Tk is formed in the black area 72 of the code image forming area 71. Thus, in the code image forming area 71 of the embossed paper P, the difference in level between the convex portion Pa and the concave portion Pb can be reduced.

### COMPARATIVE EXAMPLE

The 5C of the figure shows, as a comparative example, a cross section of the embossed paper P in a case where base images are formed with uniform thicknesses in the code image forming areas 71 of the embossed paper P. In the code image forming area 71 of the embossed paper P, the white toner layer Tw is formed as the base image in both the convex portions Pa and the concave portions Pb at a constant density (thickness). The black toner layer Tk is formed in the black area 72 of the code image forming area 71. In the comparative example illustrated in 5C of the drawing, the difference in level between the convex portions Pa and the concave portions Pb remain in the code image forming area 71 of the embossed paper P.

In general, the pattern of embossed paper is not regular. Therefore, the pattern of the area on the embossed paper where the code image is formed is not uniform and varies from one sheet to another.

The first sheet reading section 30 reads patterns of the embossed papers supplied to the image forming section 40 one by one. The controller 11 generates image data of a base image according to the pattern (unevenness information) of the embossed paper, and controls the image forming section 40 to form the base image. The controller 11 can form a base image that matches the unevenness of the sheet. Thus, the controller 11 can fill the concave portions of the embossed paper with the base image and smooth out the unevenness on the surface of the sheet. Therefore, the controller 11 can improve the difference in level of the code image even if the embossed pattern is different for each sheet.

Although the case of forming a code image has been mainly described above as an example, the same applies to the case of forming an inspection image, a test pattern image, a registration mark image, or the like.

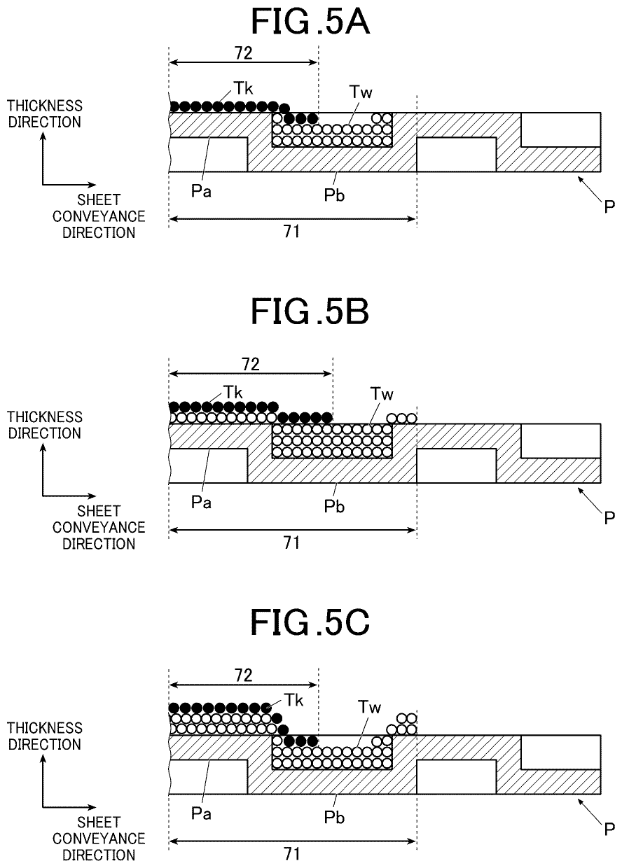

FIG. 6 is a flowchart illustrating first image forming position correction processing executed in the image forming apparatus 10. The first image forming position correction processing is processing of forming a correction base image (patch image) on embossed paper and calculating a correction value for an image forming position. This processing is implemented by software processing in cooperation with the CPU of the controller 11 and a program stored in the ROM.

First, the controller 11 controls the conveyance section 17 to cause it to convey a correction sheet (embossed paper) from a specified one of the sheet feed trays 21, 22, and 23 of the sheet feed section 20 toward the first sheet reading section 30. The controller 11 controls the first sheet reading section 30 to read the surface of the correction sheet and generate a first read image (step S11). The method of reading the correction sheet is the same as step S3 of the image forming processing (refer to FIG. 4). The controller 11 may cause the first sheet reading section 30 to read the surface of the correction sheet only in a area where the correction base image is formed (correction base image forming area).

Next, the controller 11 acquires the unevenness information of the correction base image forming area from the first read image (step S12). The position of the correction base image forming area is determined in advance.

Next, the controller 11 generates the image data of the correction base image based on the unevenness information of the correction base image forming area (step S13). The method for generating the image data of the correction base image is the same as that in step S5 of the image forming processing (see FIG. 4).

Next, the controller 11 controls the image forming section 40 to form the correction base image on the correction sheet on the basis of the image data of the correction base image (step S14). To be specific, the controller 11 causes the image creating section 41W to form a white toner image (correction base image) on the photosensitive drum 42W. The controller 11 causes the white toner image formed on the photosensitive drum 42W to be transferred onto the intermediate transfer belt 47. The controller 11 causes the secondary transfer roller 48 to transfer the correction base image formed on the intermediate transfer belt 47 onto the correction sheet. The controller 11 causes the fixing section 49 to fix the correction sheet on which the correction base image has been transferred.

Next, the controller 11 controls the conveyance section 17 to cause the conveyance section 17 to convey the correction sheet after image formation toward the second sheet reading section 50. The controller 11 controls the second sheet reading section 50 to cause it to read the surface of the correction sheet on which the correction base image has been formed and generate a second read image (step S15). For single-sided printing, the controller 11 allows the reading sensor 51 to read the upper surface of the embossed paper. In double-sided printing, the controller 11 allows the reading sensors 51 and 52 to read the upper and lower surfaces of embossed paper. The controller 11 acquires the second read image from the second sheet reading section 50. The controller 11 may allow the second sheet reading section 50 to read the surface of the correction sheet only in the correction base image forming area and the peripheral area thereof.

Next, the controller 11 performs binarization processing on an area of the second read image that is wider than the correction base image forming area (step S16). Here, the controller 11 may change the parameters of the image processing such that the correction base image forming area of the image data of the second read image has higher sharpness than the surrounding area (such that the edge is emphasized).

Next, the controller 11 calculates, from the binarized second read image (binarized image), the misregistration amount of the correction base image with respect to the correction sheet (step S17). Specifically, the controller 11 calculates the misregistration amount of the correction base image by performing pattern matching of the binarized image with the first read image generated by the first sheet reading section 30 as a reference image. Here, the controller 11 may set a area wider than the “area in which the correction base image is estimated to be formed” as a processing target with respect to the binarized image. For example, a result obtained by multiplying the size of the QR code image by an arbitrary magnification (a value larger than 1) is used as the matching area. A binarized image may also be used as the first read image serving as the reference image.

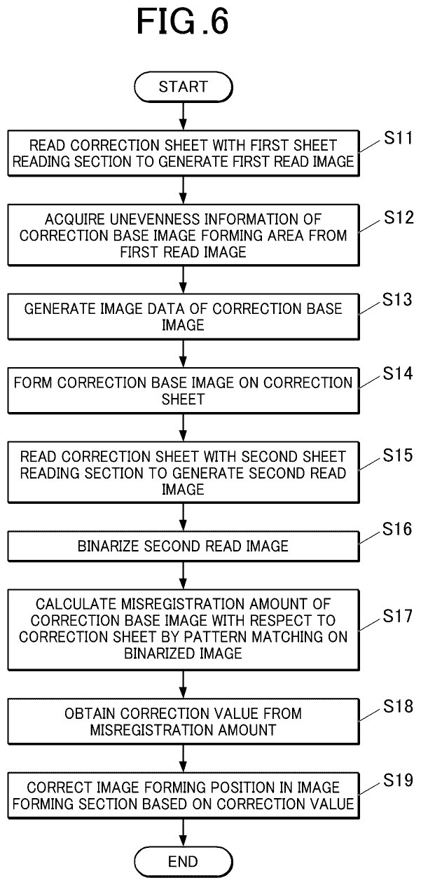

The 7A of the figure shows an example of embossed paper P1 (correction sheet) on which a correction base image 91 has been formed. In FIG. 7A, a direction indicated by an arrow X is a main scanning direction, and a direction indicated by an arrow Y is a sub-scanning direction. FIG. 7A is an example in which the correction base image 91 is not shifted with respect to the embossed paper P1.

FIG. 7B illustrates an example of a binarized image Q1 obtained by binarizing the second read image obtained by reading the embossed paper P1 with the second sheet reading section 50. The controller 11 performs pattern matching on the binarized image Q1 using the first read image as a reference image. In the binarized image Q1, the uneven pattern (grooves) is continuous inside and outside a area 101 corresponding to the correction base image. That is, the binarized image Q1 substantially matches the reference image (first read image). Therefore, the controller 11 estimates that there is no misregistration between the embossed pattern of the embossed paper P1 and the correction base image 91.

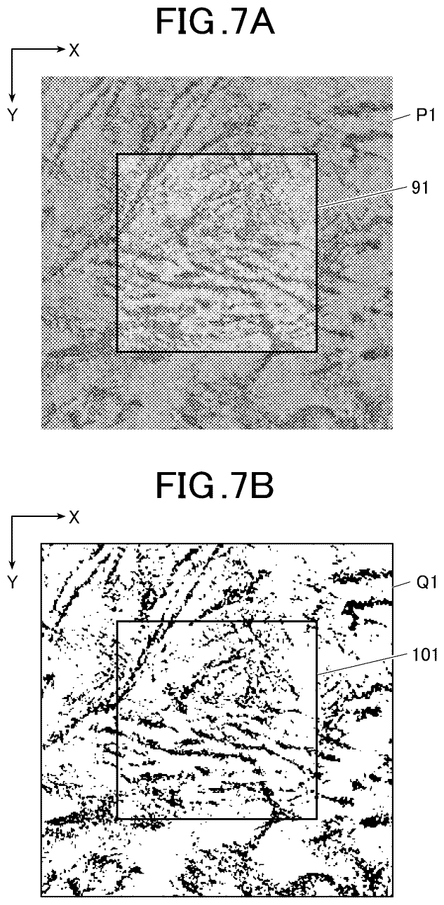

FIG. 8A shows another example of embossed paper P2 (correction sheet) on which a correction base image 92 is formed. In FIG. 8A, the correction base image 92 is formed at a position shifted from the target area 93 on the embossed paper P2. The target area 93 is a area targeted as a area in which the correction base image is to be formed, and is a area in which the unevenness information is acquired when the image data of the correction base image is generated. FIG. 8A is an example of a case where the correction base image 92 is displaced from the target area 93 on the embossed paper P2. Specifically, they are shifted by Δx in the main scanning direction X and by Δy in the sub-scanning direction Y.

FIG. 8B illustrates an example of a binarized image Q2 obtained by binarizing a second read image obtained by reading embossed paper P2 with the second sheet reading section 50. The controller 11 performs pattern matching on the binarized image Q2 using the first read image as a reference image, and calculates the misregistration amount between the embossed pattern on the embossed paper P2 and the correction base image 92. The controller 11 extracts, from the binarized image Q2, a area that does not match the reference image (first read image) as a area 102 corresponding to the correction base image. Further, the controller 11 specifies a area 103 corresponding to the target area from the binarized image Q2. In the binarized image Q2, it is ideal that the correction base image is formed in a area 103 corresponding to the target area, but the correction base image is actually formed in a area 102 corresponding to the correction base image. As a result, in the binarized image Q2, the uneven pattern (grooves) is shifted inside and outside the area 102 corresponding to the correction base image.

The controller 11 calculates a misregistration amount Δx in the main scanning direction X and a misregistration amount Δy in the sub-scanning direction Y. In the binarized image Q2, the upper left vertex of a area 103 (rectangular area) corresponding to the target area is defined as coordinates (x1, y1), and the upper left vertex of a area 102 (rectangular area) corresponding to the correction base image is defined as coordinates (x2, y2). The misregistration amounts Δx and Δy are obtained by the following expressions.

$$Δ x = x 2 - x 1$$

$$Δ y = y 2 - y 1$$

If the degree of similarity between the binarized image Q2 and the reference image (first read image) is less than a preset value as a result of the pattern matching processing, the controller 11 may determine that the misregistration is too large to calculate correction values and re-form a correction base image on another correction sheet.

Next, the controller 11 obtains correction values for the image forming positions in the image forming section 40 from the misregistration amounts (step S18).

Next, the controller 11 corrects the image forming position in the image forming section 40 based on the correction values (step S19). Thereafter, when the controller 11 controls the image forming section 40 to form an image on a sheet, the image forming position is corrected using the correction value.

Thus, the first image forming position correction processing is completed.

According to the first embodiment, the controller 11 of the image forming apparatus 10 generates the image data of the correction base image based on the unevenness information of the surface of the correction sheet acquired from the first read image generated by the first sheet reading section 30. The controller 11 controls the image forming section 40 to form the correction base image on the correction sheet on the basis of the image data of the correction base image. The controller 11 causes the second sheet reading section 50 to read the correction sheet on which the correction base image is formed and generate a second read image. The controller 11 obtains, from the second read image, a correction value for the image forming position in the image forming section 40, and corrects the image forming position in the image forming section 40 based on the correction value. Therefore, the controller 11 can improve the position accuracy of the base image formed on the sheet having unevenness. Furthermore, the controller 11 can adjust the image forming position without forming a registration mark image.

For example, the controller 11 calculates, from the second read image, a misregistration amount of the correction base image with respect to the correction sheet by pattern matching or the like, and obtains a correction value from the misregistration amount. Thus, the controller 11 can easily improve the accuracy of the position of the base image.

The controller 11 acquires unevenness information of the surface of the sheet from the read image generated by the first sheet reading section 30. The controller 11 generates image data of the base image on the basis of the unevenness information acquired from the read image. For example, the controller 11 generates the image data of the base image in accordance with the density distribution corresponding to the unevenness on the surface of the sheet in the read image. The controller 11 controls the image forming section 40 to form a base image on a sheet on the basis of the image data of the base image. The controller 11 can improve the reproducibility of an image formed on a sheet having unevenness by leveling the unevenness of the surface of the sheet with the base image.

The controller 11 causes a base image to be formed in a partial area on the sheet. For example, the controller 11 allows the base image to be formed in an area on the sheet where the code image, the inspection image, the test pattern image, or the registration mark image is to be formed. The controller 11 allows the base image to be formed only in an area where an image is formed such that the function of the image is impaired due to the unevenness of the surface of the sheet. Accordingly, the controller 11 can suppress the consumption of the color material for the base image.

For example, since the controller 11 causes the base image to be formed in the area on the sheet where the code image is to be formed, the code image can be accurately formed. Thus, it is possible to reduce a misreading rate when a sheet on which a code image is formed is read by a code reader.

In addition, since the controller 11 causes the base image to be formed in the area in which the inspection image, the test pattern image, and the registration mark image are formed, each image can be accurately formed. Thus, the controller 11 can accurately perform the inspection, adjustment, processing, and the like performed using each image.

Furthermore, the controller 11 causes the base image to be formed in a color different from that of the image in the image forming job. Thus, the controller 11 can flatten out the unevenness on the surface of the sheet without interrupting the formation of the image in the image forming job.

Note that the calculation of the misregistration amount by the pattern matching processing has been described in the first embodiment. Alternatively, the controller 11 may detect the position of the correction base image by detecting a white patch image or the like from the second read image generated by reading the correction sheet on which the correction base image is formed. Specifically, the controller 11 can detect the correction base image by detecting the difference in shading between the embossed paper and the correction base image or detecting the edge of the correction base image. Next, the controller 11 calculates, as the misregistration amount, the difference between the position where the correction base image is to be formed and the position where the correction base image is actually formed on the correction sheet.

### Second Embodiment

Next, a second embodiment to which the present invention is applied will be described.

An image forming apparatus according to the second embodiment has the same configuration as the image forming apparatus 10 according to the first embodiment, so that FIG. 1 and FIG. 2 are referred to and description of the same constituent parts is omitted. Hereinafter, configurations and processes characteristic of the second embodiment will be described.

In the second embodiment, the controller 11 of the image forming apparatus 10 forms a plurality of correction base images on a correction sheet to obtain the optimum conditions of the image forming positions.

The controller 11 controls the image forming section 40 to form a plurality of correction base images on the correction sheet while changing conditions related to the image forming position in the image forming section 40.

The controller 11 causes the second sheet reading section 50 to read the correction sheet on which the plurality of correction base images are formed and generate a second read image.

The controller 11 detects areas corresponding to the plurality of correction base images from the second read image, and selects, as a condition for obtaining a correction value, a condition corresponding to an area having the smallest shading difference among the detected areas. That is, the controller 11 determines that the position of the correction base image having the smallest shading difference among the plurality of correction base images is the correct coordinate.

Next, operation of the image forming apparatus 10 according to the second embodiment will be described.

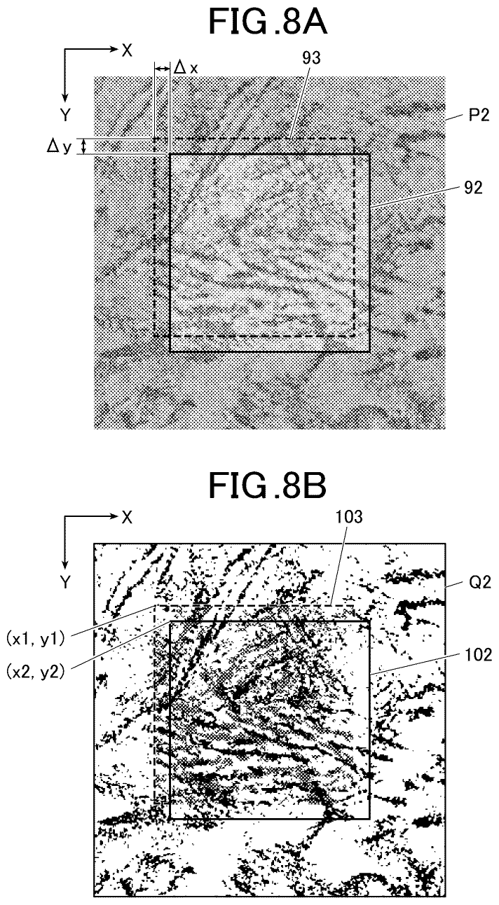

FIG. 9 is a flowchart illustrating second image forming position correction processing executed in the image forming apparatus 10. The second image forming position correction process is a process of forming a plurality of correction base images on the embossed paper and obtaining a correction value related to the image forming position based on a difference in shading in each correction base image. This processing is implemented by software processing in cooperation with the CPU of the controller 11 and a program stored in the ROM.

The processing in step S21 is similar to the processing in step S11 in the first image forming position correction processing (refer to FIG. 6), and therefore, description thereof is omitted.

Next, the controller 11 acquires, from the first read image, unevenness information of the plurality of correction base image forming areas (step S22). The reference position of each correction base image forming area is determined in advance.

Next, the controller 11 generates image data of the correction base image while changing the position condition for each area (correction base image forming area) based on the unevenness information of each area (step S23).

Next, the controller 11 controls the image forming section 40 to form a plurality of correction base images on the correction sheet (step S24).

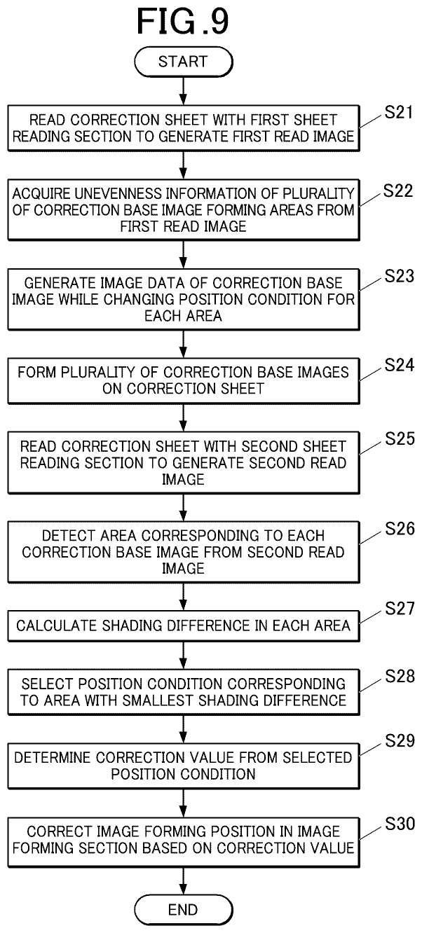

FIG. 10 illustrates an example of embossed paper P11 on which a plurality of correction base images 111 to 119 are formed.

The controller 11 forms the correction base images 111 to 119 on the embossed paper P11 while shifting each of the correction base images 111 to 119 from the reference position by a predetermined value in each of the main scanning direction X and the sub-scanning direction Y and changing the position condition. For example, in FIG. 10, the controller 11 changes the position of each of the correction base images 111 to 119 in the main scanning direction X to −x, 0, and +x around the reference position. The controller 11 changes the position of each of the correction base images 111 to 119 in the sub-scanning direction Y to −y, 0, and +y around the reference position.

Next, the controller 11 controls the second sheet reading section 50 to cause it to read the surface of the correction sheet having the plurality of correction base images formed thereon and generate a second read image (step S25). The controller 11 acquires the second read image from the second sheet reading section 50. The controller 11 may cause the second sheet reading section 50 to read the surface of the correction sheet only in the correction base image forming area.

Next, the controller 11 detects areas corresponding to the respective correction base images from the second read image (step S26).

Next, the controller 11 calculates the shading difference in each area (step S27). For example, the controller 11 calculates the difference between the maximum value and the minimum value of the density in the area to be processed as the shading difference.

Next, the controller 11 selects a position condition corresponding to an area having the smallest shading difference among the plurality of areas (step S28).

Next, the controller 11 obtains correction values related to the image forming position in the image forming section 40 from the selected position conditions (step S29). Next, the controller 11 corrects the image forming position in the image forming section 40 based on the correction values (step S30). That is, the controller 11 sets the position condition selected in step S28 as the optimum condition, and sets the correction values (various setting values) corresponding to the position condition as the conditions at the time of image formation.

Thus, the second image forming position correction processing is completed.

According to the second embodiment, the controller 11 of the image forming apparatus 10 can improve the position accuracy of the base image formed on the sheet having unevenness. In the second embodiment, the controller 11 causes a plurality of correction base images to be formed while changing the conditions related to the image forming position. The controller 11 detects areas corresponding to the plurality of correction base images from the second read image generated by the second sheet reading section 50, and selects, as a condition for obtaining a correction value, a condition corresponding to an area having the smallest shading difference among the detected areas. The controller 11 uses a small shading difference as a criterion for determining that the position accuracy of the correction base image is high, thus allowing easy correction of the image forming position. Furthermore, the controller 11 can adjust the image forming position without forming a registration mark image.

Although the example in which the nine correction base images 111 to 119 are formed on the embossed paper P11 is illustrated in FIG. 10, the number of correction base images formed on the correction sheet is not limited to this example. By increasing the number of correction base images, the number of options for selecting a condition for obtaining a correction value increases, and it is possible to efficiently find a correction value related to an image forming position.

Furthermore, in the second embodiment, the case where a plurality of correction base images are formed on one sheet has been described. Alternatively, the controller 11 may form a plurality of correction base images on two or more separate sheets under different conditions related to the image forming position.

### Third Embodiment

Next, a third embodiment to which the present invention is applied will be described.

An image forming apparatus according to the third embodiment has the same configuration as the image forming apparatus 10 according to the first embodiment, and thus FIG. 1 and FIG. 2 are referred to, and description of the same components is omitted. Hereinafter, configurations and processes characteristic of the third embodiment will be described.

In the third embodiment, the position accuracy of image formation is evaluated based on the formation state of a code image.

The controller 11 of the image forming apparatus 10 controls the image forming section 40 to form the plurality of correction base images and the code image on the correction sheet while changing conditions related to the image forming position in the image forming section 40. Here, the controller 11 allows the plurality of correction base images and the code image to be formed such that the layer of the code image is placed on the side of the correction base image opposite to the correction sheet. The code image is a code image having information in a one dimensional or two dimensional direction.

The controller 11 causes the second sheet reading section 50 to read the correction sheet on which the plurality of correction base images and the code image are formed, and generate a second read image.

The controller 11 detects areas corresponding to the plurality of correction base images from the second read image, and selects, as a condition for obtaining a correction value, a condition corresponding to a area having the smallest misreading rate of the code image among the detected areas.

Next, operation of the image forming apparatus 10 according to the third embodiment will be described.

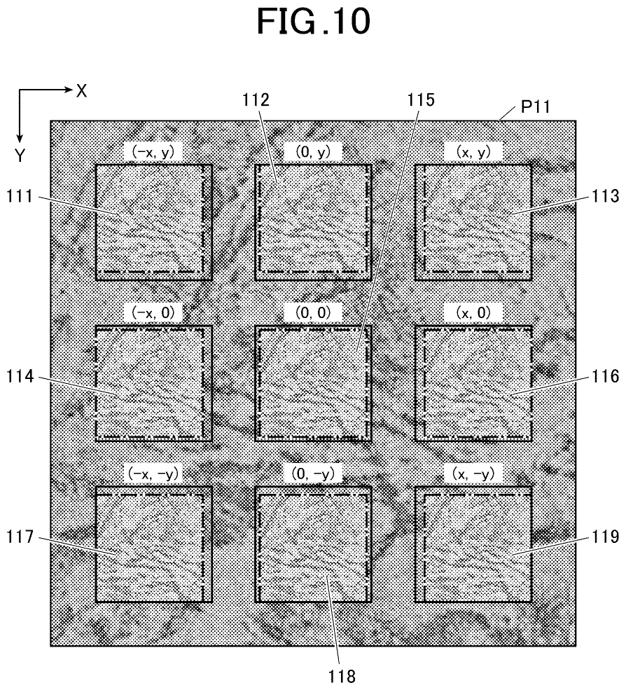

FIG. 11 is a flowchart illustrating third image forming position correction processing executed in the image forming apparatus 10. The third image forming position correction processing is processing in which a plurality of correction base images and code images are formed on embossed paper, and a correction value is obtained based on the misreading rate of each code image. This processing is implemented by software processing in cooperation with the CPU of the controller 11 and a program stored in the ROM.

Since the processing of steps S31 to S33 is the same as the processing of steps S21 to S23 in the second image forming position correction processing (refer to FIG. 9), the description will be omitted.

Next, the controller 11 combines the code image with each area of the correction base image (correction base image forming area) (step S34). In order to make it possible to compare the misreading rates of the code images in the respective areas, the same code image is added to the respective areas.

Next, the controller 11 controls the image forming section 40 to form the plurality of correction base images and the code image (barcode, QR code, or the like) on the correction sheet (step S35).

For example, the controller 11 causes the image creating section 41K to form a black toner image (code image) on the photosensitive drum 42K. The controller 11 causes the black toner image formed on the 42K of the photosensitive drum to be transferred onto the intermediate transfer belt 47.

The controller 11 causes the image creating section 41W to form a white toner image (correction base image) on the photosensitive drum 42W. The controller 11 causes the white toner image formed on the photosensitive drum 42W to be transferred onto the intermediate transfer belt 47. Here, on the intermediate transfer belt 47, a white toner image is formed outside the area where the code image is formed.

The controller 11 causes the secondary transfer roller 48 to collectively transfer the code image and the correction base image formed on the intermediate transfer belt 47 onto the correction sheet. The controller 11 causes the fixing section 49 to fix the code image and the correction base image on the transferred correction sheet.

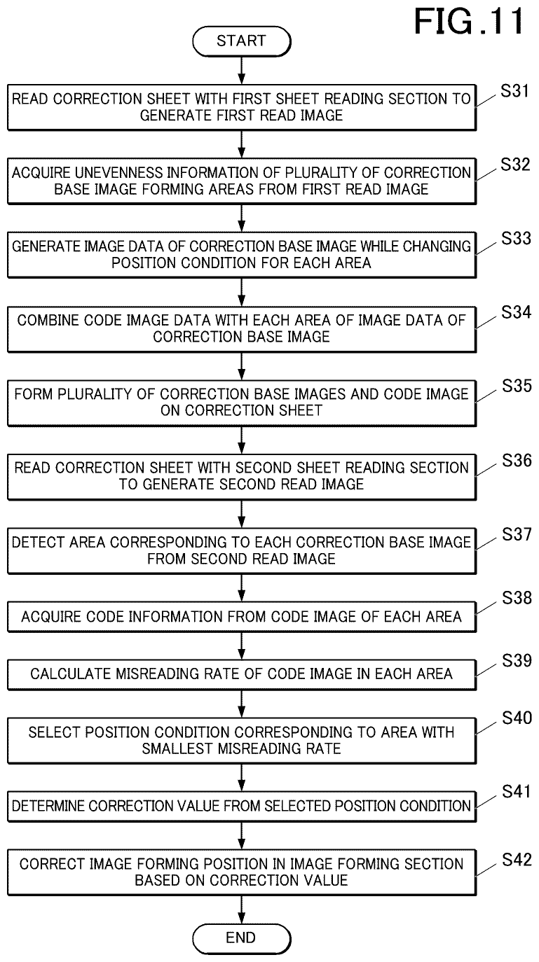

FIG. 12 illustrates an example of the embossed paper P21 on which a plurality of correction base images 121 to 129 and code images 131 to 139 are formed.

The controller 11 shifts each of the correction base images 121 to 129 and the code images 131 to 139 from the reference position by a predetermined value in the main scanning direction X and the sub-scanning direction Y, respectively, with respect to the embossed paper P21. The controller 11 forms the correction base images 121 to 129 and the code images 131 to 139 while assigning the position conditions in this manner. For example, in FIG. 12, the controller 11 changes the position of each of the correction base images 121 to 129 and the code images 131 to 139 in the main scanning direction X to −x, 0, and +x around the reference position. The controller 11 changes the positions of the correction base images 121 to 129 and the code images 131 to 139 in the sub-scanning direction Y to −y, 0, and +y from the reference position.

Next, the controller 11 controls the second sheet reading section 50 to read the surface of the correction sheet on which the plurality of correction base images and the code image have been formed, and to generate a second read image (step S36). The controller 11 acquires the second read image from the second sheet reading section 50. The controller 11 may cause the second sheet reading section 50 to read the surface of the correction sheet only in the correction base image forming area.

Next, the controller 11 detects areas corresponding to the respective correction base images from the second read image (step S37). In each area, a code image is also formed. Next, the controller 11 acquires code information from the code image in each area (step S38). The controller 11 acquires information indicated by the code image by a decoding algorithm of the code image.

Next, the controller 11 compares the code information acquired from the code image in each area with the correct answer to calculate the misreading rate of the code image in each area (step S39). The misreading rate is a ratio of the number of times of misreading to the number of times of reading of the code image.

Next, the controller 11 selects a position condition corresponding to a area having the smallest misreading rate among the plurality of areas (step S40).

Next, the controller 11 obtains correction values related to the image forming position in the image forming section 40 from the selected position conditions (step S41).

Next, the controller 11 corrects the image forming position in the image forming section 40 based on the correction values (step S42). That is, the controller 11 sets the position condition selected in step S40 as the optimum condition, and sets the correction values (various setting values) corresponding to the position condition as the conditions at the time of image formation.

Thus, the third image forming position correction processing ends.

According to the third embodiment, the controller 11 of the image forming apparatus 10 can improve the position accuracy of a base image formed on a sheet having unevenness. In the third embodiment, the controller 11 causes a plurality of correction base images and code images to be formed while changing the conditions related to the image forming position. The controller 11 detects areas corresponding to the plurality of correction base images from the second read image generated by the second sheet reading section 50, and selects, as a condition for obtaining a correction value, a condition corresponding to a area having the smallest rate of misreading of the code image among the detected areas. Since the controller 11 determines that the position accuracy of the correction base image is high when the misreading rate is low, the image forming position can be easily corrected. Furthermore, the controller 11 can adjust the image forming position without forming a registration mark image.

Although FIG. 12 illustrates the example in which the nine correction base images 121 to 129 and the nine code images 131 to 139 are formed on the embossed paper P21, the number of correction base images and code images to be formed on the correction sheet is not limited to this example. By increasing the number of correction base images and code images, the number of options for selecting a condition for obtaining a correction value increases, and it is possible to efficiently find a correction value related to an image forming position.

Furthermore, in the third embodiment, the case where a plurality of correction base images and code images are formed on one sheet has been described. Instead of this, the controller 11 may form a plurality of correction base images and code images on two or more sheets with different conditions for the image forming position.

Note that although the case where the base image (including the correction base image) is formed with the white toner has been described in each of the above embodiments, the base image may be formed with the transparent toner in the third embodiment. Further, in each exemplary embodiment, the image forming apparatus 10 may form a base image with a toner of a color other than white and transparent. In this case, the image forming section 40 may include an image creating section corresponding to a color for forming a base image instead of the image creating section 41W.

Alternatively, the image forming apparatus 10 may form the base image with toner having the same color as the sheet. For example, the image forming apparatus 10 forms the base image with white toner when the sheet is white.

### Modification Example 1

Next, modification example 1 will be described focusing on the differences from the above-described embodiments.

In Modification example 1, the controller 11 of the image forming apparatus 10 may cause image creating sections corresponding to two or more colors among the plurality of image creating sections 41Y, 41M, 41C, 41K, and 41W to form a base image.

The controller 11 controls the color or the number of colors of the base image in accordance with the density corresponding to the concave portions on the surface of the sheet in the read image generated by the first sheet reading section 30 (reading sensors 31 and 32). An area having a higher density in the read image corresponds to an area having a deeper concave portion in the sheet. The controller 11 recognizes, as the “density corresponding to concave portions in the surface of the sheet,” the density of a area in the read image where the density is higher than the density of the surroundings.

There are cases where restrictions are placed on the toners of the respective colors used in image formation, such as there being an upper limit to the amount that can be placed on a sheet. When the density corresponding to the concave portions in the surface of the sheet is lower than the predetermined threshold value, the controller 11 determines the number of colors of the base image to be “1”. On the other hand, the controller 11 determines the number of colors of the base image to be “2” when the density corresponding to the concave portion of the surface of the sheet is equal to or greater than the predetermined threshold value. A plurality of threshold values used for density comparison may be provided, and a base image may be formed with three or more colors.

In addition, the controller 11 determines the color of the base image to be “white” or “transparent” in a case where the density corresponding to the concave portion on the surface of the sheet is less than the predetermined threshold value. On the other hand, the controller 11 determines the color of the base image to be “white” and “yellow” when the density corresponding to the concave portion of the surface of the sheet is equal to or greater than the predetermined threshold value.

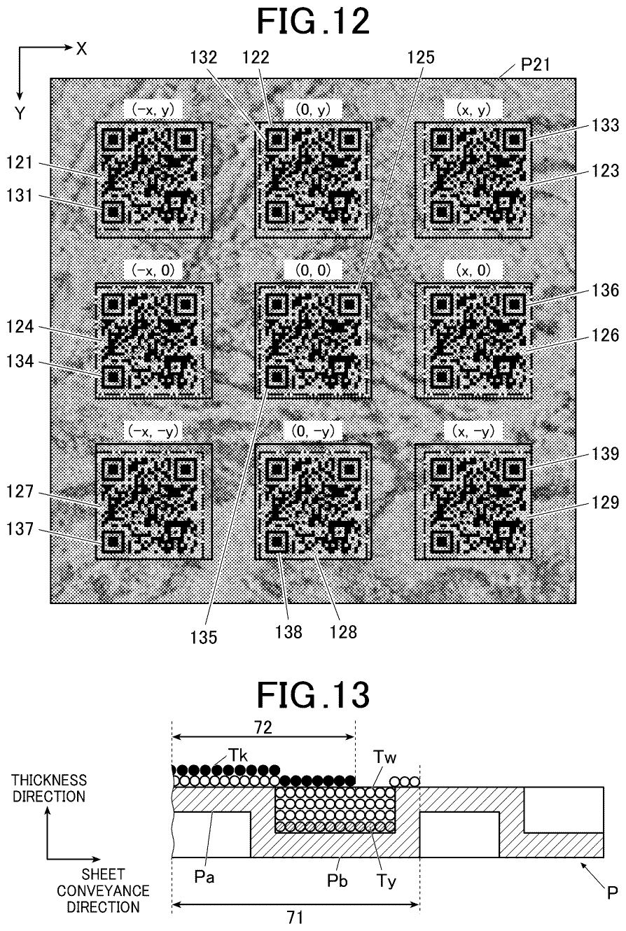

FIG. 13 is an enlarged view showing a cross section of the embossed paper P in the case where the base image is formed in the code image forming area 71 of the embossed paper P and two color toners are used for the base image of the concave portion Pb of the embossed paper P. On the convex portions Pa of the code image forming area 71, a white toner layer Tw is formed as a base image. In the concave portions Pb of the code image forming area 71, the yellow toner layer Ty and the white toner layer Tw are formed as the base image. Specifically, the yellow toner layer Ty is formed on the bottom side of the concave portion Pb, and the white toner layer Tw is formed on the top side of the concave portion Pb. The black toner layer Tk is formed in the black area 72 of the code image forming area 71. In the code image forming area 71, by forming the base image of the concave portion Pb in yellow and white, it is possible to cope with an embossed pattern having a large concave portion.

In a case where the base image is formed in two colors, an operator or the like sets the arrangement order of the image creating sections 41Y, 41M, 41C, 41K, and 41W in the image forming section 40 in advance in accordance with the formation order of the toner images. Specifically, among the image creating sections corresponding to the two colors forming the base image, the image creating section corresponding to the color on the bottom side of the concave portion is arranged to perform the primary transfer onto the intermediate transfer belt 47 later than the image creating section corresponding to the color on the upper side of the concave portion. Furthermore, the image creating sections are arranged such that the image creating section corresponding to the color of the upper side of the concave portion is primarily transferred onto the intermediate transfer belt 47 later than the image creating section corresponding to the color of the code image. For example, the black image creating section 41K, the white image creating section 41W, and the yellow image creating section 41Y are arranged in this order from the top along the intermediate transfer belt 47 illustrated in FIG. 1.

According to modification example 1, the controller 11 of the image forming apparatus 10 causes the base image to be formed in one or two colors in accordance with the density corresponding to the concave portions in the surface of the sheet in the read image. The controller 11 can form a thicker base image by overlapping toners of two colors and can fill a deeper recess.

Furthermore, the controller 11 can control the color of the base image in accordance with the density corresponding to concave portions in the surface of the sheet in the read image. For example, the controller 11 makes the color of the base image white or transparent, so that the main image is less likely to be influenced. Furthermore, the controller 11 can form a thicker base image by using yellow in addition to white as the color of the base image. Furthermore, yellow has a smaller influence on the main image than magenta and cyan.

### Modification Example 2

Next, modification example 2 will be described focusing on differences from the above-described embodiments.

In a case of forming a base image, toner images in respective colors needs to be formed on the intermediate transfer belt 47 during a period from when a sheet is read in the first sheet reading section 30 until a leading edge of the sheet reaches the position of the secondary transfer roller 48. However, there may be a case where the timing at which the image data of the base image is generated from the read image and the base image formed on the intermediate transfer belt 47 reaches the position of the secondary transfer roller 48 is later than the timing at which the leading end of the sheet reaches the position of the secondary transfer roller 48. In this case, the controller 11 of the image forming apparatus 10 temporarily circulates the sheet through the conveyance path for double-sided printing and causes an image to be formed on the second surface of the sheet. The second surface is a side that has been the lower surface when the sheet has passed through the first sheet reading section 30. Specifically, the controller 11 sends the sheet to the reversing section 171 without forming an image on the sheet in the image forming section 40. Then, the controller 11 causes the image forming section 40 to form a base image on the sheet reversed by the reversing section 171 and supplied again.

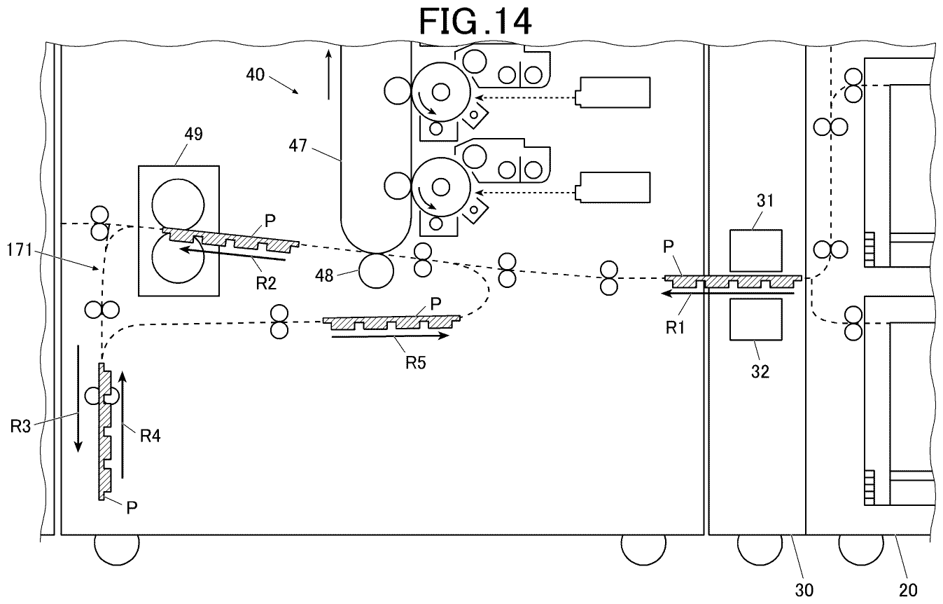

FIG. 14 is an enlarged view illustrating the vicinity of the reversing section 171. The embossed paper P fed from the sheet feed section 20 passes through a conveyance path R1 and is read by the first sheet reading section 30. Then, the embossed paper Pis conveyed to the fixing section 49 through the conveyance path R2 without the toner image being transferred to the first surface from the intermediate transfer belt 47. The embossed paper P that has passed through the fixing section 49 is conveyed again to the front of the secondary transfer roller 48 through the conveyance paths R3, R4, and R5 by the reversing section 171. In FIG. 14, for easy understanding of the front and back of the embossed paper P, unevenness are provided only on the second surface side of the embossed paper P.

In this way, the embossed paper P conveyed to the secondary transfer roller 48 again via the reversing section 171 is conveyed such that the second surface faces the intermediate transfer belt 47. Therefore, the controller 11 causes the image (base image and document image) to be formed first from the second surface. Before the image formation on the second surface, the controller 11 generates image data of the base image for the second surface from the read image obtained by the reading sensor 32.

After an image is formed on the second surface of the embossed paper P in the image forming section 40, the controller 11 feeds the sheet again to the reversing section 171 and returns the sheet to the front of the secondary transfer roller 48. Next, the controller 11 forms an image on the first surface in the image forming section 40, and then ejects the sheet to the sheet ejection tray 61 or the sheet ejection tray 62.

According to modification example 2, the controller 11 of the image forming apparatus 10 causes a base image to be formed on the sheet that has been reversed by the reversing section 171 and supplied again. Thus, the controller 11 can secure the processing time required for acquiring the unevenness information from the read image and generating the image data of the base image.

When there is a distinction between the front and the back of the sheet, the controller 11 may cause the base image and the document image to be formed on the first surface of the sheet by causing the sheet to pass through the reversing section 171 twice (idle feeding).

### Modification example 3

Next, modification example 3 will be described focusing on differences from the above-described embodiments.

In a case where the unevenness information on the surface of the sheet is common to each of the plurality of sheets, the controller 11 of the image forming apparatus 10 controls the image forming section 40 to form the base image formed on the first sheet among the plurality of sheets also on the second and subsequent sheets. The case where the unevenness information is common includes the case where the pattern of the embossed paper has regularity.

For example, when forming code images and the like in the same area of multiple sheets embossed with the same pattern, the controller 11 uses the image data of the base image generated for the first sheet.

In addition, the controller 11 may store the image data of the base image in the storage section 12 and may use the image data of the base image stored in the storage section 12 when forming the code image or the like in the same area of the sheet having the same pattern later.

In a case where the unevenness information is common to each of the plurality of sheets, it is not necessary to read the sheets one by one. According to the modification example 3, the controller 11 of the image forming apparatus 10 can divert the base image formed on the first sheet to the formation of the second and subsequent sheets.

For example, even when it takes time to generate the image data of the base image as in the modification example 2, the second and subsequent sheets can be processed without being reversed by the reversing section 171. Thus, the controller 11 can improve productivity.

Note that the descriptions in the above embodiments and modification examples are examples of the image forming apparatus, the image forming method, and the recording medium according to the present invention, and are not limited thereto. The detailed configuration and detailed operation of each component constituting the device can also be appropriately changed without departing from the spirit of the present invention.

For example, whether or not to form a base image on a sheet may be selectable in the image forming apparatus. Further, in the image forming apparatus, it may be possible to select whether to form a base image corresponding to the unevenness of the surface of the sheet or to form a base image with a uniform density.

In each of the above-described embodiments and modification examples, in the image forming apparatus of the intermediate transfer type, the case where the toner images are simultaneously transferred from the intermediate transfer belt 47 onto the sheet in the state in which the main image (document image including the code image and the like) and the base image are superimposed on the intermediate transfer belt 47 has been described. Alternatively, in an image forming apparatus using a direct transfer method, the base image may be transferred onto a sheet, then the main image may be transferred onto the sheet, and the base image and the main image may be fixed at the same time. Furthermore, in the image forming apparatus, after the base image is formed on the sheet, the sheet may be conveyed to the image forming section again, and the main image may be formed so as to be superimposed on the base image.

Further, the present invention is not limited to an electrophotographic image forming apparatus and may be applied to an inkjet image forming apparatus. An inkjet image forming apparatus first ejects ink for forming a base image onto a sheet, and then ejects ink for forming a main image onto the sheet.

Although an example in which a ROM is used as a computer-readable medium storing a program for executing each processing has been disclosed in the above description, the present invention is not limited to this example. As other computer-readable media, a nonvolatile memory such as a flash memory and a portable recording medium such as a CD-ROM may be applied. Furthermore, a carrier wave may be applied as a medium for providing data of the program via a communication line.

Although embodiments of the present invention have been described and shown in detail, the disclosed embodiments are made for purposes of illustration and example only and not limitation. The scope of the present invention should be interpreted by terms of the appended claims.

What is claimed is:

1. An image forming apparatus comprising:
a conveyer that conveys a sheet;
an image former that forms an image on the sheet;
a first sheet reader provided on an upstream side from the image former in a sheet conveyance direction;
a hardware processor that causes the first sheet reader to read the sheet and generate a read image, generates image data of a base image based on unevenness information of a surface of the sheet acquired from the read image, and controls the image former to form the base image on the sheet based on the image data of the base image; and
a second sheet reader provided on a downstream side from the image former in the sheet conveyance direction, wherein the hardware processor
causes the first sheet reader to read a correction sheet and generate a first read image,
generates image data of a correction base image based on unevenness information of a surface of the correction sheet acquired from the first read image,
controls the image former to form the correction base image on the correction sheet based on the image data of the correction base image,
causes the second sheet reader to read the correction sheet on which the correction base image is formed and generate a second read image,
obtains a correction value related to an image forming position in the image former from the second read image, and
corrects the image forming position in the image former based on the correction value.

2. The image forming apparatus according to claim 1, wherein the hardware processor calculates, from the second read image, a misregistration amount of the correction base image with respect to the correction sheet and obtains the correction value from the misregistration amount.

3. The image forming apparatus according to claim 1, wherein
the hardware processor
controls the image former to form a plurality of correction base images on the correction sheet by changing a condition related to the image forming position in the image former, each of the correction base images being the correction base image, and
detects areas corresponding to the plurality of the correction base images from the second read image and selects a condition corresponding to an area having a smallest shading difference among the detected areas, as a condition for obtaining the correction value.

4. The image forming apparatus according to claim 1, wherein
the hardware processor
controls the image former to form a plurality of correction base images and a code image having information in a one dimensional direction or two dimensional direction on the correction sheet such that a layer of the code image is placed on a side of the correction base images opposite to the correction sheet, by changing a condition related to the image forming position in the image former, each of the correction base images being the correction base image, and
detects areas corresponding to the plurality of the correction base images from the second read image, and selects a condition corresponding to an area having a smallest misreading rate of the code image among the detected areas, as a condition for obtaining the correction value.

5. The image forming apparatus according to claim 1, wherein the hardware processor causes the base image to be formed in a partial area on the sheet.

6. The image forming apparatus according to claim 5, wherein the partial area is an area in which an inspection image, a test pattern image, a registration mark image, or a code image having information in a one dimensional direction or two dimensional direction is formed.

7. The image forming apparatus according to claim 1, wherein
the image former includes a plurality of image creators to form images in mutually different colors, and
the hardware processor causes the base image to be formed in a color different from a color of an image in an image forming job.

8. The image forming apparatus according to claim 7, wherein the hardware processor causes image creators corresponding to two or more colors among the plurality of the image creators to form the base image.

9. The image forming apparatus according to claim 7, wherein the hardware processor controls the color or a number of the color of the base image in accordance with a density corresponding to a concave portion on the surface of the sheet in the read image.

10. The image forming apparatus according to claim 1, further comprising s a reverser that reverses the sheet conveyed to the downstream side from the image former in the sheet conveyance direction and supplies the reversed sheet to the image former again, wherein
the hardware processor sends the sheet to the reverser without causing the image former to form an image on the sheet and causes the image former to form the base image on the sheet reversed by the reverser and supplied again.

11. The image forming apparatus according to claim 1, wherein the unevenness information of the surface of the sheet is common to each of a plurality of sheets, and the hardware processor controls the image former to form the base image, which has been formed on a first sheet of the plurality of the sheets, on second and subsequent sheets.

12. An image forming method in an image forming apparatus including: a conveyer that conveys a sheet; an image former that forms an image on the sheet; a first sheet reader that is provided on an upstream side from the image former in a sheet conveyance direction; and a second sheet reader that is provided on a downstream side from the image former in the sheet conveyance direction, the method comprising:
causing the first sheet reader to read the sheet and generate a read image;
generating image data of a base image based on unevenness information of a surface of the sheet acquired from the read image;
controlling the image former to form the base image on the sheet based on the image data of the base image;
causing the first sheet reader to read a correction sheet and generate a first read image;
generating image data of a correction base image based on unevenness information of a surface of the correction sheet acquired from the first read image;
controlling the image former to form the correction base image on the correction sheet based on the image data of the correction base image;
causing the second sheet reader to read the correction sheet on which the correction base image is formed and generate a second read image;
obtaining a correction value related to an image forming position in the image former from the second read image; and
correcting the image forming position in the image former based on the correction value.

13. A non-transitory recording medium storing a computer-readable program for a computer of an image forming apparatus including: a conveyer that conveys a sheet; an image former that forms an image on the sheet; a first sheet reader provided on an upstream side from the image former in a sheet conveyance direction; and a second sheet reader provided on a downstream side from the image former in the sheet conveyance direction, the program causing the computer to perform:
causing the first sheet reader to read the sheet and generate a read image;
generating image data of a base image based on unevenness information of a surface of the sheet acquired from the read image;
controlling the image former to form the base image on the sheet based on the image data of the base image;
causing the first sheet reader to read a correction sheet and generate a first read image;
generating image data of a correction base image based on unevenness information of a surface of the correction sheet acquired from the first read image;
controlling the image former to form the correction base image on the correction sheet based on the image data of the correction base image;
causing the second sheet reader to read the correction sheet on which the correction base image is formed and generate a second read image;
obtaining a correction value related to an image forming position in the image former from the second read image; and
correcting the image forming position in the image former based on the correction value.
